(19) United States
(12) Patent Application Publication
(10) Pub. No.: US 2006/0020866 A1
(43) Pub. Date: Jan. 26, 2006

(54) System and method for monitoring performance of network infrastructure and applications by automatically identifying system variables or components constructed from such variables that dominate variance of performance

(75) Inventors: Kevin H. Lo, La Canada, CA (US); Richard Y. Chung, Seattle, WA (US)

Correspondence Address: WILMER CUTLER PICKERING HALE AND DORR LLP, 60 STATE STREET, BOSTON, MA, 02109, US

(73) Assignee: K5 Systems Inc.

(21) Appl. No.: 11/153,049

(22) Filed: Jun. 15, 2005

Related U.S. Application Data
(60) Provisional application No. 60/579,984, filed on Jun. 15, 2004.

(51) Int. Cl. G01R 31/28; G06F 11/00

(52) U.S. Cl. 714/741

(57) ABSTRACT

Systems, methods and computer program products for monitoring performance of network infrastructure and applications by automatically identifying system variables or combinations constructed from such variables that dominate variance of system performance. A method, system and computer program monitors performance of executing software applications and execution infrastructure components to detect deviations in performance. Logic acquires data from executing software applications and execution infrastructure, said data including descriptive data variables and outcomes data variables. Other logic statistically analyzes said acquired data to identify instances where the statistical description of operating behavior deviates from expected operating behavior and to indicate with a statistically significant probability that an operating anomaly exists within said executing software applications and execution infrastructure; and logic, cooperating with the logic to statistically analyze, filters out non-essential variables in the acquired data from being utilized by the logic to statistically analyze, such that remaining variables and combinations thereof account for a substantial contribution in the variance of performance of the executing software applications and execution infrastructure.

### CROSS-REFERENCE TO RELATED APPLICATIONS

This application claims priority under 35 U.S.C. §119(e) to U.S. Provisional Patent Application No. 60/579,984 filed on Jun. 15, 2004, entitled Methods and Systems for Determining and Using a Software Footprint, which is incorporated herein by reference in their entirety.

This application is related to the following U.S. patent applications (Nos. TBA), filed on an even date herewith, entitled as follows:
System and Method for Monitoring Performance of Arbitrary Groupings of Network Infrastructure and Applications;
System and Method for Monitoring Performance of Network Infrastructure and Applications by Automatically Identifying System Variables or Components Constructed from Such Variables that Dominate Variance of Performance; and
Method for Using Statistical Analysis to Monitor and Analyze Performance of New Network Infrastructure or Software Applications Before Deployment Thereof.

### BACKGROUND

1. Technical Field

This invention generally relates to the field of software and network systems management and more specifically to monitoring performance of groupings of network infrastructure and applications using statistical analysis.

2. Discussion of Related Art

In today's information technology (IT) operating environments, software applications are changing with increasing frequency. This is in response to security vulnerabilities, rapidly evolving end-user business requirements and the increased speed of software development cycles. Furthermore, the production environments into which these software applications are being deployed have also increased in complexity and are often interlinked and inter-related with other ‘shared’ components.

Software application change is one of the primary reasons for application downtime or failure. For example, roughly half of all software patches and updates within enterprise environments fail when being applied and require some form IT operator intervention. The issues are even worse when dealing with large scale applications that are designed and written by many different people, and when operating environments need to support large numbers of live users and transactions.

The core of the problem is rooted in the software release decision itself and the tradeoff that is made between the risks of downtime and application vulnerability. All changes to the software code can have un-intended consequences to other applications or infrastructure components. Thus far, the inability to quantify that risk in the deployment of software means that most decisions are made blindly, oftentimes with significant implications.

The current approach to increasing confidence in a software release decision is done through testing. There are a number of tools and techniques that address the various stages of the quality assurance process. The tools range from the use of code verification and complier technology to automated test scripts to load/demand generators that can be applied against software. The problem is: how much testing is enough?

Ultimately, the complication is that the testing environments are simply different from production environments. In addition to being physically distinct with different devices and topologies, testing environments also differ in regards to both aggregate load and the load curve characteristics. Furthermore, as infrastructure components are shared across multiple software applications, or when customers consume different combinations of components within a service environment, of when third party applications are utilized or embedded within an application, the current testing environments are rendered particularly insufficient.

As the usage of software applications has matured, corporations have grown increasingly reliant upon software systems to support mission critical business processes. As these applications have evolved and grown increasingly complex, so have the difficulties and expenses associated with managing and supporting them. This is especially true of distributed applications delivered over the Internet to multiple types of clients and end-users.

Software delivered over the Internet (vs. on a closed network) is characterized by frequent change, software code deployed into high volume and variable load production environments, and end-user functionality may be comprised of multiple ‘applications’ served from different operating infrastructures and potentially different physical networks. Managing availability, performance and problem resolution requires new capabilities and approaches.

The current state of the technology in application performance management is characterized by several categories of solutions.

The first category is the monitoring platform; it provides a near real-time environment focused on alerting an operator when a particular variable within a monitored device has exceeded a pre-determined performance threshold. Data is gathered from the monitored device (network, server or software application) via agents, (or via an agent-less techniques, or directly outputted by the code) and they are aggregated in a single database. In situations where data volumes are large, the monitoring information may be reduced, filtered or summarized and/or stored across a set of coordinated databases. Different datatypes are usually normalized into a common format and rendered through a viewable console. Most major systems management tools companies like BMC, Net IQ, CA/Unicenter, IBM's (Tivoli), HP (HPOV), Micromuse, Quest, Veritas and Smarts provides these capabilities.

A second category consists of various analytical modules that are designed to work in concert with a monitoring environment. These consist of (i) correlation, impact and root-cause analysis tools, (ii) performance tools based on synthetic transactions and (iii) automation tools. In general, these tools are designed to improve the efficiency of the operations staff as they validate actual device or application failure, isolate the specific area of failure and resolve the problem and restore the system to normal. For example, correlation/impact tools are intended to reduce the number of false positives, help isolate failure by reducing the number of related alerts. Transactional monitoring tools help operators create scripts in order to generate synthetic transactions which are applied against a software application; by measuring the amount of time required to process the transaction, the operator is able to measure performance from the application's end-user perspective. Automation tools frameworks on which operators can pre-define relationships between devices and thresholds and automate the workflow and tasks for problem resolution.

A third category of newer performance management tools are designed to augment the functionality of the traditional systems management platforms. While these offer new techniques and advances, they are refinements of the existing systems rather than fundamentally new approaches to overall performance management. The approaches taken by these companies can be grouped into 5 broad groupings:
(a) The first are various techniques that adjust the thresholds within the software agents monitoring a target device. Whereas in existing systems management tools, if a threshold is exceeded, an alert gets sent; this refinement allows the real time adjustment of these thresholds based on a pre-defined methodology or policy intended to reduce the number of false positives generated by the monitoring environment.
(b) The second are tools focusing on using more advanced correlation techniques, typically limited to base pair correlation, in order to try and enhance suppression of false alarms and to better identify the root cause of failures.
(c) The third are tools uses historical end-user load to make predictions about the demands placed on existing IT systems. These will typically involve certain statistical analysis of the load curves which can be combined with other transactional monitors to assist in capacity planning and other performance related tasks.
(d) Fourth, there are point technologies that are focused on provide performance management within only a particular portion of the application stack. Examples include providers of database management and application servers tools that are intended to optimize an individual piece of the overall application system.
(e) Finally, there are a set of tools and frameworks that help visualize and track monitored performance statistics along a business process that may span several software applications. These systems leverage an existing monitoring environment for gauge and transactional data; by matching up these inputs and outputs, they're able to identify when particular application failure impacts the overall business service.

In general, while these 3 categories of tools often provide IT operations staffs with a high degree of flexibility, these systems management tools also require extensive customization for each application deployment and have high on-going costs associated with changes made to the application and infrastructure. Additionally, these tools are architected to focus on individual applications, servers or other discrete layer of the infrastructure and not well designed to suit the needs of managing performance across complex and heterogeneous multi-application systems. Finally and most importantly, these tools are fundamentally reactive in nature in that they're designed to identify specific fault and then enable efficient resolution of problems after such occurrences.

### SUMMARY

The invention provides systems, methods and computer program products for monitoring performance of network infrastructure and applications by automatically identifying system variables or combinations constructed from such variables that dominate variance of system performance.

Under one aspect of the invention, a method, system and computer program monitors performance of executing software applications and execution infrastructure components to detect deviations in performance. Logic acquires data from executing software applications and execution infrastructure, said data including descriptive data variables and outcomes data variables. Other logic statistically analyzes said acquired data to identify instances where the statistical description of operating behavior deviates from expected operating behavior and to indicate with a statistically significant probability that an operating anomaly exists within said executing software applications and execution infrastructure; and logic, cooperating with the logic to statistically analyze, filters out non-essential variables in the acquired data from being utilized by the logic to statistically analyze, such that remaining variables and combinations thereof account for a substantial contribution in the variance of performance of the executing software applications and execution infrastructure.

Under another aspect of the invention, the logic to statistically analyze acquired data includes principal component analysis (PCA) logic to perform principal component analysis on said acquired data to create principal components to represent variance in performance of the executing software applications and execution infrastructure.

Under another aspect of the invention, the logic to filter out discards from subsequent statistical analysis by said logic to statistically analyze principal components that contribute insignificantly to variance in performance of the executing software applications and execution infrastructure.

Under another aspect of the invention, the PCA logic creates eigenvectors and associated eigenvalues to represent principal sources of variation in performance of the executing software applications and execution infrastructure.

Under another aspect of the invention, the logic to filter out non-essential variables includes logic to identify eigenvectors with relatively small eigenvalues and discards principal components whose eigenvectors have relatively small eigenvalues from subsequent statistical analysis.

Under another aspect of the invention, the executing software applications and execution infrastructure is a managed unit comprised of an arbitrary, unconstrained selection of executing software applications and execution infrastructure.

Under another aspect of the invention, the logic to statistically analyze said acquired data to identify instances where the statistical description of operating behavior deviates from expected operating behavior operates in real-time with the execution of the applications and execution infrastructure.

Under another aspect of the invention, the acquired data includes monitored data.

Under another aspect of the invention, the acquired data includes business process data.

Under another aspect of the invention, training logic trains the statistical analysis logic to changing behavior of the software applications and execution infrastructure.

Under another aspect of the invention, the PCA logic includes logic to group principal components to facilitate analysis.

Under another aspect of the invention, the training logic includes logic to subsequently train the user-configured values.

### BRIEF DESCRIPTION OF DRAWINGS

In the drawing,

FIG. 1 depicts the overall architecture of certain embodiments of the invention;

FIG. 2 depicts the Process Overview of certain embodiments of the invention;

FIG. 3 depicts Pre-Processing logic of certain embodiments of the invention;

FIG. 4 depicts logic for determining the footprint or composite metric of certain embodiments of the invention;

FIG. 5 depicts logic for comparing the footprint or composite metric of certain embodiments of the invention;

FIG. 6 depicts logic for determining the principal component (PC) diff of certain embodiments of the invention; and

FIG. 7 depicts logic for training certain embodiments of the invention.

### DETAILED DESCRIPTION

Preferred embodiments of the invention provide a method, system and computer program that simultaneously manages multiple, flexible groupings of software and infrastructure components based on real time deviations from an expected normative behavioral pattern (Footprint).

Footprint: Each Footprint is a statistical description of an expected pattern of behavior for a particular grouping of client applications and infrastructure components (Managed Unit). This Footprint is calculated using a set of mathematical and statistical techniques; it contains a set of numerical values that describe various statistical parameters. Additionally, a set of user configured and trainable weights as well as a composite control limit are also calculated and included as a part of the Footprint.

Input Data: These calculations are performed on a variety of input data for each Managed Unit. The input data can be categorized into two broad types: (a) Descriptive data such as monitored data and business process and application specific data; and (b) Outcomes or fault data.

Monitored data consists of SNMP, transactional response values, trapped data, custom or other logged data that describes the performance behavior of the Managed Unit.

Business process and application specific data are quantifiable metrics that describe a particular end-user process. Examples are: total number of Purchase Orders submitted; number of web-clicks per minute; percentage of outstanding patient files printed.

Outcomes data describe historical performance and availability of the systems being managed. This data can be entered as a binary up/down or percentage value for each period of time.

There are no limitations on the type of data entered into the system as long as it is in time series format at predictable intervals and that each variable is a number (counter, gauge, rate, binary).

Likewise, there is no minimum or maximum number of variables for each time period. However, in practice, a minimum number of variables are required in order to generate statistically significant results.

Managed Unit: A Managed Unit is a logical construct that represent multiple and non-mutually exclusive groupings of applications and infrastructure components. In other words, a single application can be a part of multiple Managed Units at the same time; equally, multiple applications and infrastructures can be grouped into a single logical construct for management purposes.

Within each Management Unit, a flexible hierarchical structure allows the mapping of the physical topology. In other words, specific input variables for a specific device are grouped together; Devices are grouped into logical Sub-systems, and Sub-systems into Systems.

Defining the Baseline Operating Condition: A Footprint is first calculated using historical data or an ‘off-line’ data feed for a period of time. The performance and behavior of Managed Unit during this period of time, whether good or bad, is established as the reference point for future comparisons.

A Managed Unit's Baseline Footprint can be updated as required. This updating process can be machine or user initiated.

Real Time Deviations: In a real-time environment, a Footprint for a particular Managed Unit is calculated for each moving window time slice. The pace or frequency of the polled periods is configurable; the size of the window itself is also configurable.

Once the moving window Footprint is calculated, it is compared against the Baseline Footprint. The process of comparing the Footprints yields a single composite difference metric that can be compared against the pre-calculated control limit. A deviation that exceeds the control limit indicates a statistically significant probability that an operating anomaly exists within the Managed Unit. In a real time environment, this deviation metric is calculated for each polled period of time.

For example, in the case where the Baseline was established during normal operating conditions, a significant and persistent deviation between the two metrics is an early indication that abnormal behavior or fault condition exists within the Managed Unit. A trigger or alarm is sent; this indicates the user should initiate a pre-emptive recovery or remediation process to avoid availability or performance disruption.

Inherent Functionality/Training Loops: The combination of algorithms used to calculate the Footprint inherently normalizes for deviations in behavior driven by changes in demand or load. Additionally, the process ‘filters’ out non-essential variables and generates meta-components that are independent drivers of behavior rather than leaving these decisions to users.

Training or self-learning mechanisms in the methods allow the system to adjust the specific weights, thresholds and values based on actual outcomes. The system uses actual historical or ‘off-line’ data to first establish a reference point (Footprint) and certain configured values. Next, the system processes the real time outcomes alongside the input data and uses those to make adjustments.

The construct of Managed Units allows for users to mirror the increasingly complex and inter-linked physical topology while maintaining a single holistic metric.

Implementation: The system and computer program is available over a network. It can co-process monitored data along-side existing tools providing additional predictive capabilities or function stand-alone processor of monitored data.

Applications of the System: The system can be used to compare a client system with itself across configurations, time or with slightly modified (e.g., patched) versions of itself. Further, once a reference performance pattern is determined, it can be used as a reference for many third party clients deploying similar applications and/or infrastructure components.

Additionally, because the units of management within the system are logical constructs and management is based on patterns rather than specific elements tied to physical topology, the system is effective in managing eco-systems of applications—whether resident on a single or multiple 3^{rd} party operating environments.

Architecture and Implementation:

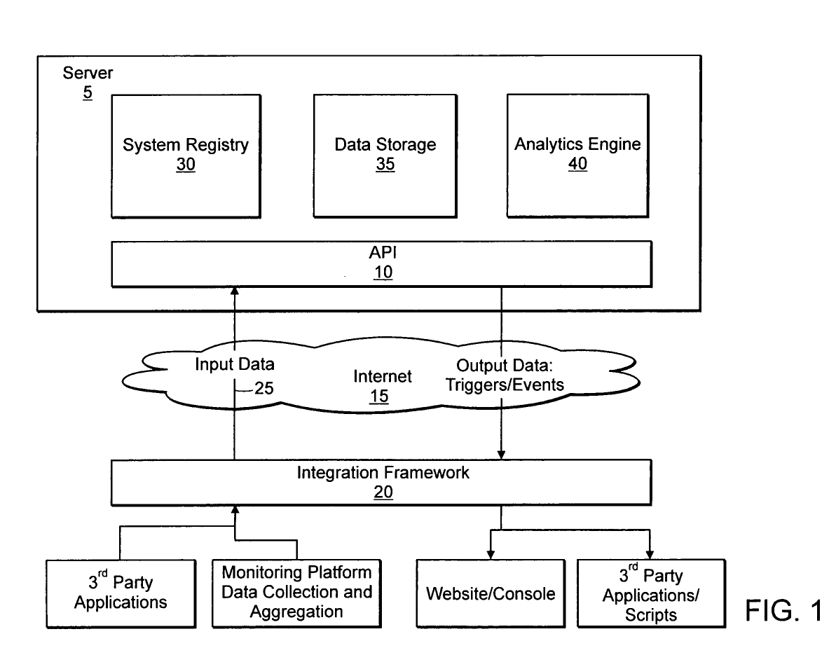

FIG. 1 shows the overall context of preferred embodiment of the invention. There is a server 5 that provides the centralized processing of monitored/polled input data on software applications, hardware and network infrastructure. The servers are accessed through an API 10 via the Internet 15; in this case, using a web services protocol. The API can be accessed directly or in conjunction with certain 3^{rd} party tools or integration frameworks 20.

The server 5 is comprised of 3 primary entities: an Analytics Engine 40 that processes the input data 25; a System Registry 30 which maintains a combination of historical and real time system information, and the Data Storage layer 35 which is a repository for processed data.

The System Registry 30 is implemented as a relational database, and stores customer and system information. The preferred embodiment contains a table for customer data, several tables to store system topology information, and several tables to store configured values and calculated values. The preferred embodiment uses the Registry both to store general customer and system data for its operations and also to store and retrieve run-time footprint and other calculated values. Information in the Registry is available to clients via the API 10.

The Data Storage layer 35 provides for the storage of processed input data. The preferred storage format for input data is in a set of RRD (Round Robin Database) files. The RRD files are arranged in a directory structure that corresponds to the client system topology. Intermediate calculations performed such as running sum and intermediate variance and covariance calculations are also stored within the files and in the Registry 30.

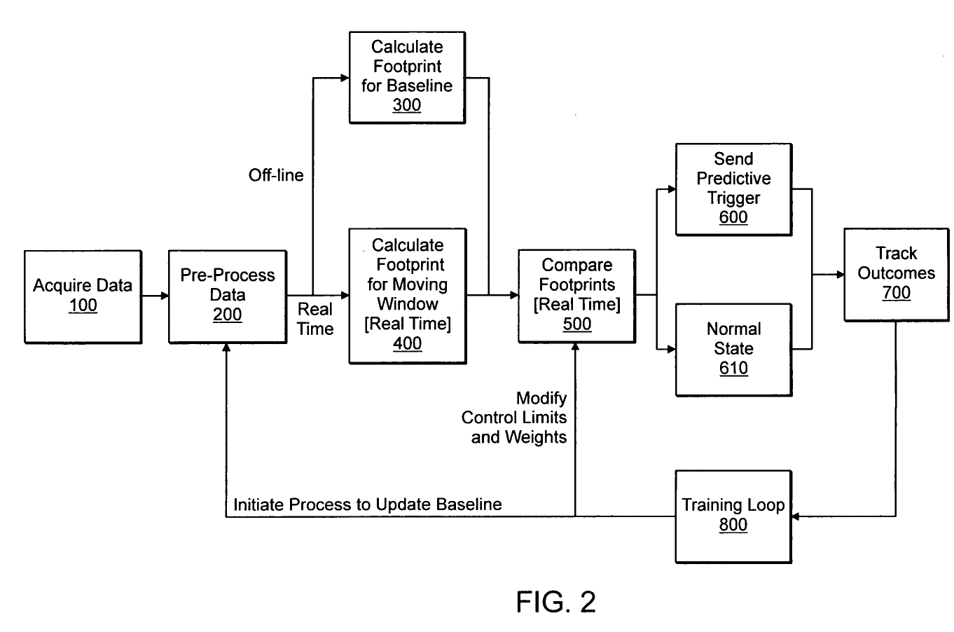

The Analytics Engine provides the core functionality of the System. The process is broken into the following primary steps shown in FIG. 2:

Step 100 is the Acquire Data step. Performance and system availability data in the form of time series variables are acquired by the Engine 40. The Engine can receive input data 25 via integration with general systems management software. The preferred embodiment of the invention exposes a web services interface (API) 10 that third-party software can access to send in data.

The API 10 exposes two broad categories of data acquisition—operations to inform the system about client system topology and preferred configuration and operations to update descriptive and fault data about managed application and infrastructures' performance and availability.

Clients of the system first initiate a network connection with the preferred embodiment of the system and send in information about the network topology and setup. This includes information about logical groupings of client system components (Managed Unit) as well as information about times series data update frequencies, and other configurable system values. This information is stored in a system registry 30. Although clients typically input system topology and configuration information at the beginning of use, they may update these values during system operation as well.

Then, at relatively regular intervals, clients of the system initiate network connections with the server 5, authenticate their identities, and then update the system with one or more data points of the descriptive data. A data point consists of the identification of a client system variable, a timestamp, and the measured value of the variable at the given timestamp. Further, whenever the client system is determined to have transitioned either from an up to a down state or vice versa as determined by an objective measure, the client system sends such a notice to the server 5 via the network API 10; This outcome or fault information is used by the software embodiment of the invention in order to calibrate and tune operating parameters both during training and in real-time.

Additionally, the server 5 exposes an interface, via the API 10 whereby clients can upload a large amount of historical descriptive and fault data easily. In the preferred embodiment, clients can upload this historical data in RRD format.

The Engine accepts multiple types and is designed to accept all available input data; the combination of algorithms used performs the distillation and filtering of the critical data elements.

The preferred embodiment of the invention accepts input data in RRD format, which simplifies the process of ensuring data format and integrity performed by the Engine (Step 200). RRD (Round Robin Database) is a popular open-source systems management tool that facilitates the periodic polling and storing of system metrics. The tool ensures that the values stored and retrieved all use the same polling period. RRD also supports several types of system metrics (e.g. gauges and counters) which it then stores in a file, and it contains simple logic to calculate and store rates for those variables that are designated as counters.

The polling period is generally unimportant, but should be at a fine enough scale to catch important aspects of system behavior. The preferred embodiment defaults to a polling period of 5 minutes (300 seconds).

Step 200 is the Pre-process Data step. The system can handle multiple types of input data; the purpose of the pre-processing step is to clean, verify and normalize the data in order to make it more tractable.

In particular, all of the time series data values are numbers, preferably available at regular time intervals and containing no gaps. If the raw data series do not have these characteristics, the Engine applies a simple heuristic to fill in short gaps with data values interpolated/extrapolated from lead-up data and verifies that data uses the same polling periods and are complete.

The Engine further prefers that all of the data series have a stable mean and variance. Additionally, the mean and standard deviation for all data variables are calculated for a given time window.

Finally, the Engine applies various transformations to smooth or amplify the characteristics of interest in the input data streams. All data values are normalized to zero mean and unit standard deviation. Additional techniques such as a wavelet transformation may be applied to the input data streams.

For each Managed Unit, the Engine 40 uses the pre-processed data streams in order to calculate a Baseline Footprint (not shown) and series of Moving Window Footprints (not shown) which are then compared against the Baseline.

Step 300 is the Calculate Baseline Footprint step. In this step, the baseline Footprint is generated by analyzing input data from a particular fixed period of time. The operating behavior of the client system during this period is characterized by the Footprint and then serves as the reference point for future comparisons. Although the default objective is to characterize a ‘normal’ operating condition, the particular choice of time period is user configurable and can be used to characterize a user specific condition.

This particular step is performed ‘off-line’ using either a real-time data feed or historical data. The Baseline Footprint can be updated as required or tagged and stored in the registry for future use.

Step 400 is the Calculate Moving Window Footprint step. An identical calculation to that of step 300 is applied to the data for a moving window period of time. Because the moving window approximates a real-time environment, this calculation is performed multiple times and a new moving window Footprint is generated for each polling period.

Step 500 is the Compare Footprints Step. Various ‘diff’ algorithms are applied to find component differences between the baseline Footprint and the moving window Footprint, and then a composite diff is calculated by combining those difference metrics using a set of configured and trained weights. More specifically, the Engine provides a framework to measure various moving window metrics against the baseline values of those metrics, normalize those difference calculations, and then combine them using configured and trained weights to output a single difference measurement between the moving window state and the baseline state. A threshold value or control limit is also calculated. If the composite difference metric remains within the threshold value, the system is deemed to be operating within expected normal operating conditions; likewise, exceeding the threshold indicates an out-of-bounds or abnormal operating condition. The composite difference metric and threshold values are stored in the registry.

Step 600 is the Send Predictive Trigger step. If the composite difference metric for a particular moving window is above the threshold value for a certain number of consecutive polling periods, the system is considered to be out of bounds and a trigger is fired, i.e., sent to an appropriate monitoring or management entity. The specific number of periods is user configurable; the default value is two.

In the preferred embodiment of the system, the predictive trigger initiates a pre-emptive client system recovery process. For example, once an abnormal client system state is detected and the specific component exhibiting abnormal behavior is identified, the client would, either manually or in a machine automated fashion, initiate a recovery process. This process would either be immediate or staged in order to preserve existing ‘live’ sessions; also, it would initially be implemented at a specific component level and then recursively applied as necessary to broader groupings based on success. The implication is that a client system is ‘fixed’ or at least the damage is bounded, before actual system fault occurs.

Step 610 is the Normal State step. If the difference is within the threshold, the system is considered to be in a normal state.

Step 700 is the Track Outcomes step. Actual fault information, as determined by users or other methods, is tracked along with predictions from the analysis. Because the engine indicates an out of bounds value prior to an external determination of system fault, actual fault data is corresponded to system variables at a configured time before the fault occurs.

Step 800 is the Training Loop step. The calculated analysis is compared with the actual fault information, and the resulting information is used to update the configured values used to calculate Footprints and the control limits used to measure their differences.

With regard to step 200 (pre-process data), the purpose is to take the acquired data from step 100 in its raw form and convert them into a series of data streams for subsequent processing.

This pre-processing step 200 preferably includes several sub-steps.

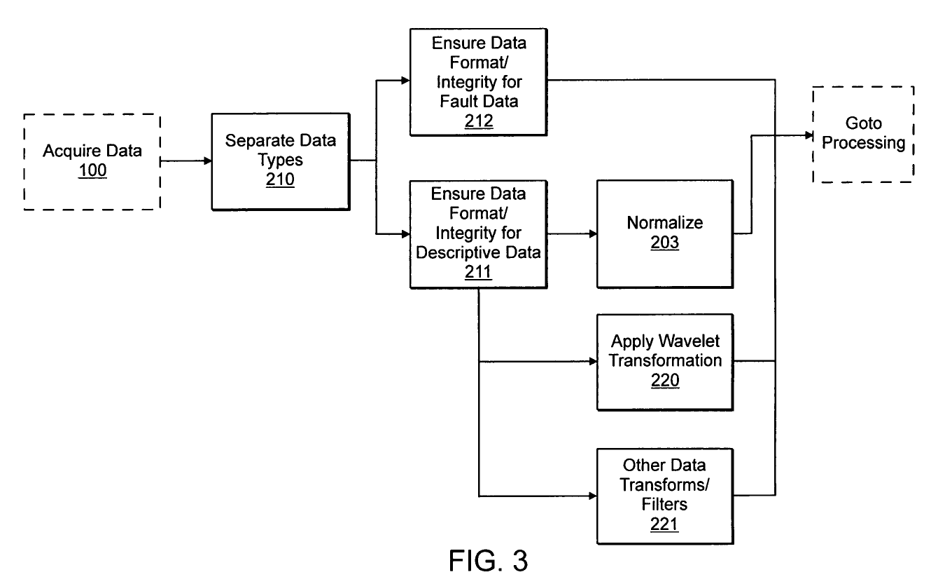

With reference to FIG. 3, sub-step 210, the engine separates the two primary types of data into separate data streams. Specifically, the descriptive data is separated from the outcomes or fault data.

With reference to FIG. 3, sub-step 211, the engine ensures data format and checks data integrity for the descriptive data. The input data, in time series format, are created at predictable time intervals, i.e. 300 or other pre-configured value. The engine ensures adherence to these default time periods. If there are gaps in the data, a linearly interpolated data value is recorded. If the data contain large gaps or holes, a warning is generated.

Second, the engine verifies that all variables have been converted into a numerical format. All data must be transformed into data streams that correspond to a random variable with a stable mean and variance. For example, a counter variable is transformed into a data stream consisting of the derivative (or rate of change) of the counter. Any data that cannot be pre-processed to meet these criteria are discarded.

Third, all descriptive data streams are normalized so that each of the data streams has a zero mean and unit variance. This is done to enable easy comparison across the various data streams.

With reference to sub-step 212, the engine ensures data format and checks data integrity for the fault or outcomes data. The format of the fault or outcomes data is either as binary up/down or as a percentage value in time series format. It is assumed that this metric underlying the fault data streams represent a user defined measure of an availability or performance level. Similar to sub-step 211, the engine verifies adherence to the pre-configured time intervals and that the data values exist. Small gaps in the data can be filled; preferably with a negative value if in binary up/down format or interpolated linearly if in percentage format. Data with large gaps or holes are preferably discarded.

With reference to FIG. 3 sub-step 220, a wavelet transform is applied to the descriptive input data in order to make the time series analyzable at multiple scales. In particular, using wavelets, the data within a time window are transformed into a related set of time series data whose characteristics should allow better analysis of the observed system. The transformation is performed on the descriptive data streams and generates new sets of processed data streams. These new sets of time series can be analyzed either along-side or in-place of the ‘non-wavelet transformed’ data sets. The wavelet transformation is a configurable user option that can be turned on or off.

With reference to FIG. 3, sub-step 230, Other Data Transforms and Filters can be applied to the input data streams of the descriptive data. Similar to sub-step 220, the Engine creates a framework by which other custom methods can be applied user configurable and generate additional.

The output from step 200 is a series of data streams in RRD format, tagged or keyed by customer. The data are stored in the database and also in memory.

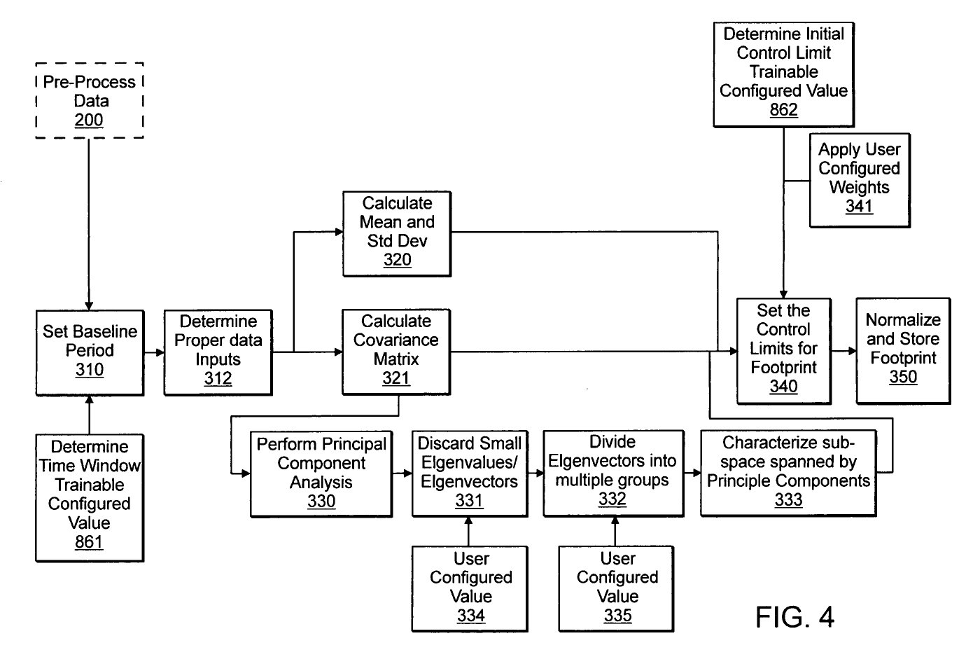

As mentioned above, after the data has been pre-processed in step 200, calculations to generate “Footprints” are performed in Steps 300 and 400. These steps are described in more detail in FIG. 4.

Step 310 sets a baseline time period. A suitable time period in which the system is deemed to be operating under normal conditions is determined. Typically, the baseline period consists of the period that starts at the beginning of data collection and ends a configured time afterwards, but users can override this default and re-baseline the system. It is this baseline period that is taken to embody normal operating conditions and against which other time windows are measured. The size of the baseline is user configurable, preferably with seconds as the unit of measure.

In Step 312, the Engine selects the appropriate data inputs from the entire stream of pre-processed data for each particular statistical technique.

In Step 320, the Engine calculates mean and standard deviations for the baseline period of time. The engine determines the mean and standard deviation for each data stream across the entire period of time. This set of means and variances gives one characterization of the input data; the Engine assumes a multivariate normal distribution. Additionally, each data series is then normalized to have zero mean and unit variance in order to facilitate further processing.

In Step 321, the Engine calculates a covariance matrix for the variables within the baseline period. In particular, the covariance for every pair of data variables is calculated and stored in a matrix. This step allows us to characterize the relationships of each input variable in relation to every other variable in a pairwise fashion. The covariance matrix is stored for further processing.

In Step 330, the Engine performs a principal component analysis on the input variables. This is used to extract a set of principal components that correspond to the observed performance data variables. Principal components represent the essence of the observed data by elucidating which combinations of variables contribute to the variance of observed data values. Additionally, it shows which variables are related to others and can reduce the data into a manageable amount. The result of this step is a set of orthogonal vectors (eigenvectors) and their associated eigenvalues which represents the principal sources of variation in the input data.

In step 331, insignificant principal components (PC) are discarded. When performing a principal component analysis, certain PCs have significantly smaller associated eigenvalues and can be assumed to correspond to rounding errors or noise. After the calculated PCs are ordered from largest to smallest by corresponding eigenvalue, the PCs with associated eigenvalues smaller than a configured fraction of the next largest PC eigenvalue are dropped. For instance, if this configured value is 1000, then as we walk down the eigenvalues of the PCs, when the eigenvalue of the next PC is less than 1/1000 of the current one, we discard that PC and all PCs with smaller eigenvalues. The result of this step is a smaller set of significant PCs which taken together should give a fair characterization of the input data, in essence boiling the information down to the pieces which contribute most to input variability.

As an input into step 331, step 334 determines the configured value for discarding small eigenvalues. The configured value is user defined. It has a default value for the system set at 1000. A specific value can be determined by doing one of the following: (a) Users can modify the default value through an off-line training process whereby the overall predictive performance of the Engine is evaluated against actual outcomes using different configured values. (b) Users can use the trained value from a Reference Managed Unit or a 3^{rd} party customer.

In step 332, the principal components are sub-divided into multiple groups. The various calculated PCs are assumed to correspond to different aspects of system behavior. In particular, PCs with a larger eigenvalue correspond to general trends in the system while PCs with a smaller eigenvalue correspond to more localized trends. The significant PCs are therefore preferably divided into at least two groups of ‘large’ and ‘small’ eigenvalues based on a configured value. Specifically, the PCs are partitioned by percentage of total sum eigenvalue, i.e. the sum of the eigenvalues of the PCs in the large bucket divided by total sum of the eigenvalues should be roughly the configured percentage of the total sum. The specific number of groups and the configured percentages are user defined.

As an input into step 332, step 335 determines the number of groupings and configured values. These configured values are user defined. The Engine starts with a default grouping of two and a configured value of 0.75. Further, a specific or custom value can be determined by doing one of the following: (a) Users can modify the default value through an off-line training process whereby the overall predictive performance of the Engine is evaluated against actual outcomes using different partitioning values (i.e., the percentage of the total sum made up by the large bucket PCs.) (b) Users can use the trained value from a Reference Managed Unit or a 3^{rd} party customer.

In step 333, the sub-space spanned by principal components is characterized. The remaining PCs are seen as spanning a subspace whose basis corresponds to the various observed variables. In this way, the calculated PCs characterize a subspace within this vector space. In particular, the Engine identifies and stores the minimum number of orthonormal vectors spanned the subspace as well as the rank (number of PCs) for future comparison with other time windows.

In step 340, the initial control limit for the composite Footprint is set. This control threshold is used by the Engine to decide whether the system behavior is within normal bounds or out-of-bounds. The initial control limit is determined through a training process (detailed in step 863) that calculates an initial value using ‘off-line’ data. Once in run-time mode, the control limit is continually updated and trained by real time outcomes data.

In step 350, the footprint is normalized and stored. The footprint is translated into a canonical form (means and standard dev of variables, PCs, orthonormal basis of the subspace, control limit etc.) and stored in Registry 30 within the server [5].

As shown in FIG. 2, while step 300 is performed as an offline process, the Footprint calculation of step 400 is performed in the run-time of the system being monitored.

Step 400 is identical to step 300 (as described in connection with FIG. 4) except in two ways. First, instead of processing the input data for the baseline period, the analysis is performed on a moving window period of time. A moving window Footprint is calculated for each time slice. Second, the moving window calculation does not require the determination of an initial control limit; thus step 340 and step 341 are not used.

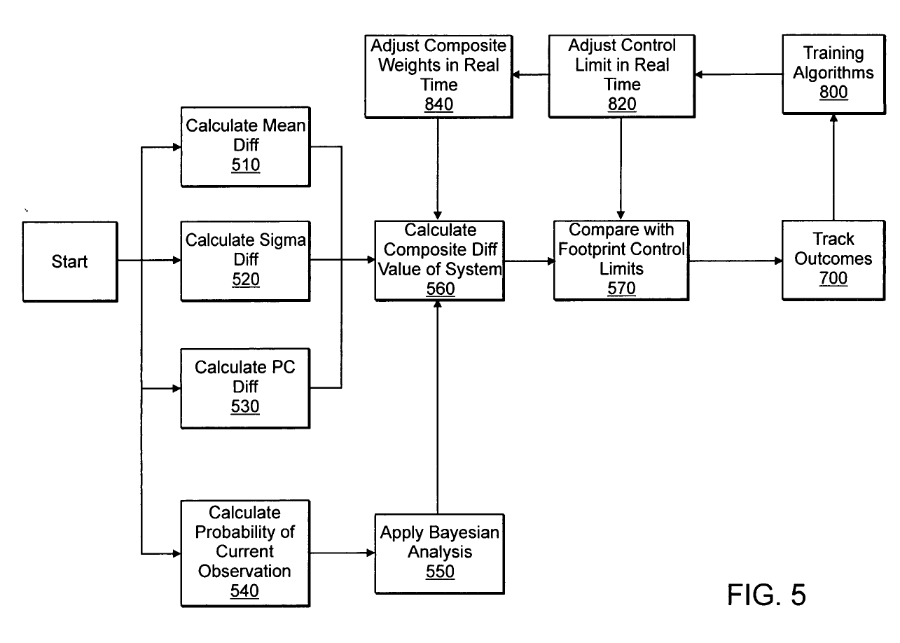

Step 500, as shown in FIG. 5, describes the process of comparing two Footprints. In a typical embodiment, a moving window Footprint is compared with the Baseline Footprint. In order to generate a composite difference metric of the current observed data values with the baseline values, component differences are first calculated and then combined.

In step 510, the mean difference is calculated. In particular, we assume the means of the n variables describe a vector in the n-space determined by the variables and calculate the “angle” between the baseline vector and the current (moving window) vector using inner products. We use the basic equation u·v=|u∥v|cos θ.

In step 520, the sigma difference is calculated. Similarly to 510, the sigmas of the variables are used to describe a vector in n-space and the baseline vector is compared with the current vector.

In step 530, the principal component difference calculated. There are two methods to do this. The first assumes each PC pair is independent and to calculate a component-wise and a composite difference. The other way is to use the concept of subspace difference or angle and compare the subspaces spanned by the two sets of PCs.

In step 540, the Engine calculates the probability of current observation. Based on the baseline mean, variance, and covariance values, a multivariate normal distribution is assumed for the input variables. The current observed values are then matched against this assumed distribution and a determination is calculated for the probability of observing the current set of values. In the preferred embodiment, one variable is selected, and the conditional distribution of that variable given that the other variables assume the observed values is calculated using regression coefficients. This conditional distribution is normal, and its conditional mean and variance are known.

Finally, the observed value of the variable is compared against this calculated mean and standard deviation, and we present the probability that an observation would be at or beyond the observed value. The system then transforms this probability value linearly into a normalized difference metric—i.e. a zero probability translates to the maximum difference value while a probability of one translates to the minimum difference value.

Step 550 applies a Bayesian analysis to the outputs of step 540. The baseline mean, variance, and covariance values may also be updated using Bayesian techniques. In particular, based on actual fault data to approximate the underlying likelihood of fault, incoming information beyond the baseline period is used to update the originally calculated values. The purpose of this step is to factor in new information with a greater understanding of system fault behavior in order to predict future behavior more accurately.

Step 560 calculates the composite difference value. The various component difference metrics are combined to create a single difference metric. Each component difference metric is first normalized to the same scale, between 0-1. Next, each component is multiplied by its pre-configured weights, and then added together to create the combined metric. For example, the Composite Diff=Ax+By+Cz where A, B and C are the configured weights that sum to 1 and x, y and z are the normalized component differences. The configured weights start with an initial value identified in step 341, but are trainable (step 800) and are adjusted in real time mode based on actual outcomes.

Should additional statistical techniques be applied to the input data (or should a particular technique generate multiple ‘equivalent’ outputs), the component difference of the new techniques would be included into the composite diff through the use of trainable configured weights.

Step 570 compares the component difference with the control limits. The newly calculated difference metric is compared to the initially calculated difference threshold from the baseline Footprint. If the control limit is exceeded, it would indicate abnormal or out-of-bounds behavior; if the difference is within the control limit, then the client system is operating with its normal expected boundary. The actual value of the control limit is trainable (step 800) and is adjusted in real time mode based on actual outcomes.

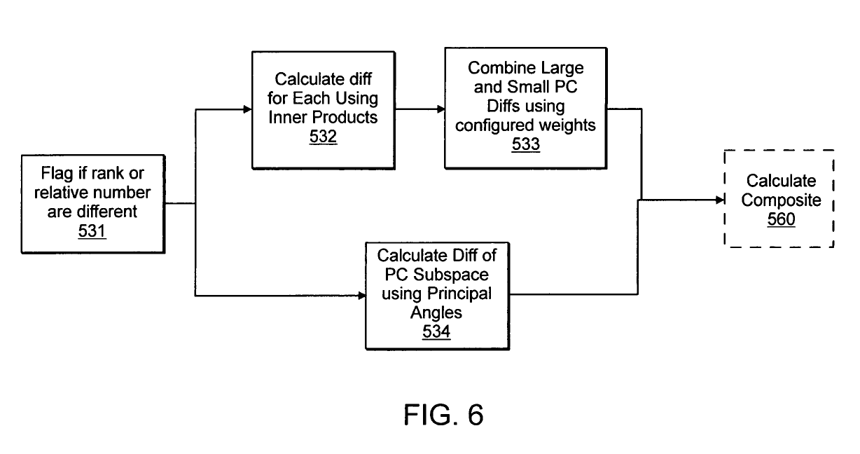

FIG. 6 depicts the sub-steps used for performing the principal component difference calculation of step 530.

Sub-step 531 first checks and compares the rank and relative number of PCs from the moving window Footprint and the Baseline. When the rank or number of significant PCs differs in a moving window, the Engine flags that as potential indication that the system is entering into an out-of-bounds phase.

There are two methods of processing the PC diffs. The first is described by sub-steps 532 and 533; the second is described by sub-steps 534. Both methods may be used concurrently or the user may select one particular method over another.

Sub-step 532 calculates the difference for each individual PC in the baseline Footprint with each corresponding PC in the moving window Footprint using inner products. In particular, this set of PCs is treated as a vector with each component corresponding to a variable, and the difference is the calculated angle between the vectors found by dividing the inner product of the vectors by the product of their norms and taking the arc cosine.

In sub-step 533, the principal component difference metrics are then sub-divided into their relevant groupings again using the configured values (number of groupings and values) from step 335. For example, if there were two groupings of PCs, one large and one small, then there would be two component difference metrics that are then inputs into step 560. Further, these two PC difference metrics can be combined using a configured weight.

Sub-step 534 begins with the characterized subspaces spanned by the groups of PCs of both the Baseline and the Moving Window Footprints. (These values are already calculated and stored as a part of the Footprint per step 350.) These characterized sub-spaces are compared by using a principal angle method which determines the ‘angle’ between the two sub-spaces. The output is a component difference metric which is then an input into step 560.

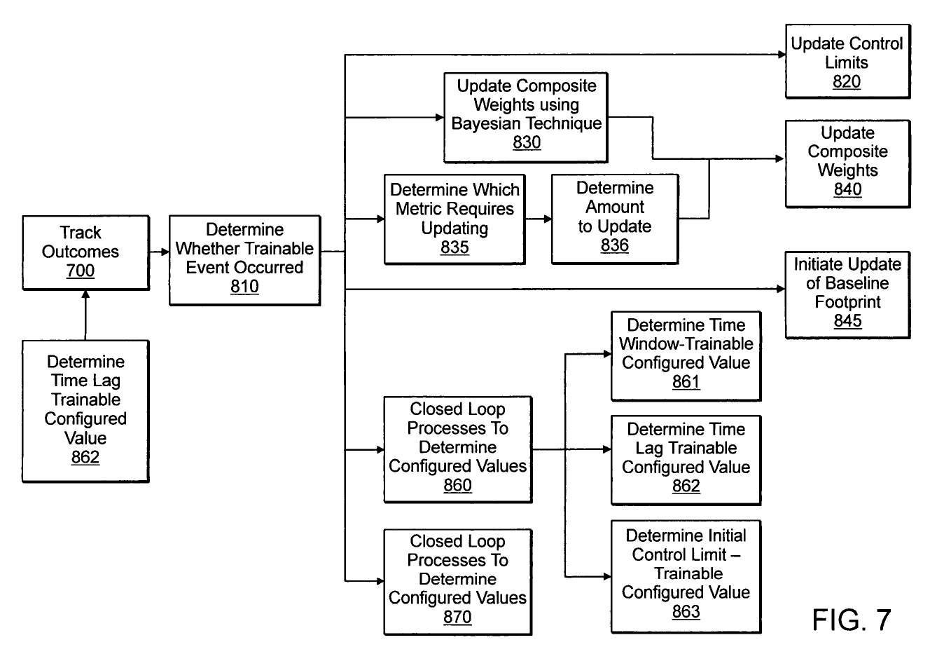

A training loop is used by the Engine to adjust the control limits and a number of the configured values based on real time outcomes and also re-initiate a new base lining process to reset the Footprint. FIG. 7 depicts the training process.

The process begins with Step 700 (also shown in FIG. 2) which tracks the outcomes. Actual fault and uptime information is matched up against the predicted client system health information. In particular, the Engine compares the in-bounds/out-of-bounds predictive metric vs. the actual binary system up/down information. For example, a predictive trigger (output of step 600) indicating potential failure would have a time stamp different from the time stamp of the actual fault occurrence. Thus evaluating accuracy would require that time stamps of the Engine's metrics are adjusted by a time lag so that the events are matched up. This time lag is a trainable configured value.

Step 810 determines whether a trainable event has occurred. After matching up the Engine's predicted state (normal vs. out of bounds) with the actual outcomes, the Engine looks for false positive (predicted fault, but no corresponding actual downtime) or false negative (predicted ok, but actual downtime) events. These time periods are determined to be trainable events. Further, time periods with accurate predictions are identified and tagged. Finally, the remaining time periods are characterized to be continuous updating/training periods.

Step 820 updates the control limits used in the step 570. When a trainable event has occurred, then the composite control limit is adjusted. The amount by which the control limit is adjusted depends on the new calculated composite value, the old control limit, and a configured percentage value. The control limit is moved towards the calculated value (i.e. up for a false positive, down for a false negative) by the configured value multiplied by the difference between the control limit and the calculated value.

The following steps 830, then 835 and 836 describe two methods for determining which composite weights, used in step 560 to calculate the composite diff metric, to adjust and the value of each adjustment. These two methods are implemented by step 840 which executes the adjustment.

Step 830 applies a standard Bayesian technique to identify and adjust the composite weights based on outcomes data. When a false positive or false negative trainable event is detected, the amounts by which the composite diff weights are adjusted are calculated using Bayesian techniques. In particular, the relative incidence of fault during the entire monitored period is used as an approximation to the underlying probability of fault. Further, the incidence of correct and incorrect predictions over the entire time period is also used in the calculation to update the weights. In short, the Engine adjusts the weights in a manner that statistically minimizes the incidence of false predictions.

Step 835 determines which metrics in step 560 need their weights updated. In situations of a false positive or false negative event, the normalized individual component diff metrics are compared with the composite threshold disregarding component weight. Metrics which contribute to an invalid prediction are flagged to have their weights updated. Those which are on the “correct” side of the threshold are not updated per se. For instance, if a metric had a value of 0.7 while the threshold was 0.8 (in-bounds behavior predicted), but availability data indicates that the system went down during the corresponding time period, then this metric would be flagged for updating. Another metric with a value of 0.85 at the same point of time would not be flagged. In continuous updating/training mode, those metrics on the “correct” side of the threshold are also updated albeit by a smaller amount.

Then, in step 836, the Engine calculates and adjusts the composite weights. Following the example above, if a metric had a value of 0.7 when the threshold was 0.8 during a time period where actual fault occurred, this metric would have its weight adjusted down by a configured percentage of the difference between the component metric value and the control limit. In other words, flagged component metrics which are further above or below the control limit have their weights diminished by more than the other flagged metrics. Then, the weights for all of the component metrics are re-normalized to sum to one. In continuous updating/training mode, “correct” metrics have a second configured training value which is usually smaller than for the false positive/false negative value.

Step 840 updates the composite weights by the adjusted values determined in steps 830 and 836.

Step 845 initiates a process to update the baseline Footprint. This process of re-baselining can be user initiated at any point in time. The machine initiated process occurs when significant flags or warnings have been sent or when the number of false positives and negatives to reach a user defined threshold.

Step 860 describes a set of training processes used to initially determine and/or continually update specific configured values within the Engine. The values are updated through the use of both ‘off-line’ and real time input data.

Step 861 determines the time windows for both the baseline and moving window Footprint calculations (step 310). The baseline period of time is preferably a longer a period of time where operating conditions are deemed to be normal; ideally there is a wide variation in end-user load. The baseline period is user determined. The moving window period defaults to four hours and is trained by closed loop process that runs a set of simulations on a fixed time period using increasingly smaller moving windows. The optimal time minimum moving window period is determined.

Step 862 determines the value of the time lag. The value can be initially set during the baseline footprint calculation by using time periods with accurate predictions (determined by step 810). The mean and standard deviations of the time lags for these accurate predictions is calculated. In real time mode, accurate events continue to update the time lag by nudging the value up or down based on actual outcomes.

Step 863 sets the control limits for the initial baseline Footprint. After calculating the footprint for the baseline period of time, the input data for that baseline period of time (step 310) is broken into n number of time slices. A moving footprint (step 400) and corresponding composite diff calculations (step 500) with the baseline Footprint are made for each of the following n time windows. In order to calculate the composites, a set of pre-assigned user determined weights are used. After the time windows have been analyzed, the mean and variance of the composite diff values are computed. The initial control limit is then set at the default of two standard deviations above the mean. This is also a user configurable value.

Preferred embodiments of the invention allow, the user to transmit various forms of descriptive and outcome or fault data to the analytics engine. The analytics engine includes logic to identify which descriptive variables, and more specifically which particular combinations of variables, account for the variations in performance of a given managed unit. These specific variables, or combinations or variables, are monitored going forward; their relative importance is determined through a training process using outcomes data and adjusted over time. This feature among other things (a) keeps the amount of data to be monitored and analyzed more manageable, (b) allows the user to initially select a larger set of data (so the user does not have to waste time culling data) while permitting the user to be confident that the system will identify the information that truly matters, and (c) identifies non-intuitive combinations of variables.

All input variables are continually fed into the engine; the calculations are only performed on variables/combinations of variables that are deemed important. We keep all variables because the ‘un-important’ variables for a component within one managed unit may be ‘important’ for that component within another managed unit. The technique can be applied to a single managed unit at different periods of time because of app shift etc.

The selection of which variables matter is done in the baseline calculation. This is re-set when the baseline is re-calculated and/or when user configured values are ‘re-set.’

Preferred embodiments of the invention calculate and derive the statistical description of behavior during moving windows of time during real time; i.e., as the managed unit groupings are executing.

Preferred embodiments of the invention provide predictive triggers so that IT professionals may take corrective action to prevent failures (as opposed to responding to failure notifications which require recovery actions to recover from failure).

Preferred embodiments manage the process of deploying modified software into an operating environment based on deviations in its expected operating behavior. The system first identifies and establishes a baseline for the operating behavioral patterns (Footprint) for a group of software and infrastructure components. Subsequently, when changes have been made to one or more of the software or infrastructure components, the system compares the Footprints of the modified state with that of the original state. IT operators are given a statistical metric that indicates the extent to which the new modified system matches the expected original normal patterns as defined by the baseline Footprint.

Based on these outputs from the system, the IT operator is able to make a software release decision based on a statistical measure of confidence that the modified application behaves as expected.

In the preferred embodiment of the invention, the system applies the Prior Invention in the following way.

Within a production environment and during run-time, the existing Baseline Footprint for a given client system (Managed Unit) is established.

Then, modifications can be made to the client system being managed. An individual or multiple changes may be applied.

The modified software or components are then deployed into the production environment. For a user defined period of time, a Moving Window Footprint is established using either multiple time slices or a single time window covering the entire period in question. The difference between the Baseline and the Moving Window Footprints is then calculated.

The Composite Difference Metric between the two is compared against the trained Control Limit of the Baseline Footprint. If the deviation between the two is within the Control Limit, then the new application behaves within the expected normal boundary. Conversely, if the deviation exceeds the control limit, then the applications are deemed to behave differently.

This method may be equally applied to an existing application, and its modified version, within a particular testing environment.

A number of variations on this process exist. For example is to perform a limited rollout of the modified software within a production environment. In this situation, the modified software would be deployed on a limited number of ‘servers’ within a larger cluster of servers such that some of the servers are running the original software and some of the servers are running the modified software. Using the same technique described above, the operating behaviors of the two different groups of servers may be compared against each other. If the modified software performs differently from expected, a rollback process is initiated to replace the modified software with the original software.

In the preferred embodiment, while there is no limit on the number of components being modified at any one time, the few components are changed, the more statistically significant the results.

Other embodiments of the system apply various techniques to refine the principal component analysis. For example, variations of the PCA algorithms can be used to address non-linear relationships between input variables. Also, various techniques can be used manipulate the matricies in the PCA calculations in order to speed up the calculations or deal with large scale calculations.

Other embodiments of the system can apply various techniques to pre-process the input data in order to highlight different aspects of the data. For example, a standard Fourier transformation can be used to get a better spectrum on frequency. Another example are additional filters that can be used to eliminate particularly noisy data.

The System's statistical processing be applied to any other system that collects and/or aggregates monitored descriptive and outcomes input for a set of targets. The intent would be to establish a normative expected behavioral pattern for that target and measure it against real time deviations such that a deviation would indicate that a reference operating condition of the target being monitored has changed. The application of the System is particularly suited to situations where any one or a combination of requirements exist: (a) there are a large and varying number of real time data variables; (b) the user requires a single metric of behavioral change from a pre-determined reference point; (c) there is a need for multiple and flexible logical groupings of physical targets that can be monitored simultaneously.

It will be further appreciated that the scope of the present invention is not limited to the above-described embodiments but rather is defined by the appended claims, and that these claims will encompass modifications and improvements to what has been described.

What is claimed:

1. A system for monitoring performance of executing software applications and execution infrastructure components to detect deviations in performance, said system comprising:
logic to acquire data from executing software applications and execution infrastructure, said data including descriptive data variables and outcomes data variables;
logic to statistically analyze said acquired data to identify instances where the statistical description of operating behavior deviates from expected operating behavior and to indicate with a statistically significant probability that an operating anomaly exists within said executing software applications and execution infrastructure; and
logic, cooperating with the logic to statistically analyze, to filter out non-essential variables in the acquired data from being utilized by the logic to statistically analyze, such that remaining variables and combinations thereof account for a substantial contribution in the variance of performance of the executing software applications and execution infrastructure.

2. The system of claim 1 wherein the logic to statistically analyze acquired data includes principal component analysis (PCA) logic to perform principal component analysis on said acquired data to create principal components to represent variance in performance of the executing software applications and execution infrastructure.

3. The system of claim 2 wherein said logic to filter out discards from subsequent statistical analysis by said logic to statistically analyze principal components that contribute insignificantly to variance in performance of the executing software applications and execution infrastructure.

4. The system of claim 3 wherein said PCA logic creates eigenvectors and associated eigenvalues to represent principal sources of variation in performance of the executing software applications and execution infrastructure.

5. The system of claim 4 wherein said logic to filter out non-essential variables includes logic to identify eigenvectors with relatively small eigenvalues and discards principal components whose eigenvectors have relatively small eigenvalues from subsequent statistical analysis.

6. The system of claim 5 wherein the logic to identify eigenvectors with relatively small eigenvalues utilizes a user-configured amount to determine whether an eigenvalue is relatively small.

7. The system of claim 1 wherein the executing software applications and execution infrastructure is a managed unit comprised of an arbitrary, unconstrained selection of executing software applications and execution infrastructure.

8. The system of claim 1 wherein the logic to statistically analyze said acquired data to identify instances where the statistical description of operating behavior deviates from expected operating behavior operates in real-time with the execution of the applications and execution infrastructure.

9. The system of claim 1 wherein the logic to statistically analyze said acquired data derives a statistical description of expected behavior and of operating behavior and said description includes at least statistical means and standard deviations of at least a subset of data elements within the acquired data.

10. The system of claim 1 wherein the logic to statistically analyze said acquired data derives a statistical description of expected behavior and of operating behavior and said description includes at least covariance matrices of at least a subset of data elements within the acquired time-series data.

11. The system of claim 1 wherein said acquired data includes monitored data.

12. The system of claim 5 wherein the monitored data includes SNMP data.

13. The system of claim 11 wherein the monitored data includes transactional response values.

14. The system of claim 11 wherein the monitored data includes trapped data.

15. The system of claim 1 wherein said acquired data includes business process data.

16. The system of claim 10 wherein the business process data describes a specified end-user process.

17. The system of claim 1 further including training logic to train the statistical analysis logic to changing behavior of the software applications and execution infrastructure.

18. The system of claim 4 wherein the PCA logic includes logic to group principal components to facilitate analysis.

19. The system of claim 18 wherein the principal components may be grouped based on size of eigenvalues to correspond to general or local trends.

20. The system of claim 17 wherein the logic to statistically analyze is responsive to user-configured values and wherein the training logic includes logic to subsequently train the user-configured values.

21. The system of claim 18 wherein the logic to statistically analyze is responsive to user-configured values and wherein the user-configured values include at least one variable to control how the PCA logic groups principal components.
